(19) United States
(12) Patent Application Publication
(10) Pub. No.: US 2009/0324175 A1
(43) Pub. Date: Dec. 31, 2009

(54) EXPANDED BEAM OPTICAL FIBRE CONNECTOR

(76) Inventors: David Edward Everett, Sudbury (GB); Dominic Patrick Daniel Curran, Sudbury (GB)

Correspondence Address: CHOATE, HALL & STEWART LLP, TWO INTERNATIONAL PLACE, BOSTON, MA, 02110, US

(21) Appl. No.: 12/297,578

(22) PCT Filed: Dec. 5, 2006
(86) PCT No.: PCT/GB06/04519

§ 371 Date: Mar. 4, 2009

(30) Foreign Application Priority Data
Apr. 18, 2006 (GB) 0607574.1

(51) Int. Cl. G02B 6/38; B23P 11/00; G02B 6/36

(52) U.S. Cl. 385/72; 385/74; 29/428; 385/93

(57) ABSTRACT

The present invention relates to an optical connector for use in a fibre optic communications system, and particularly an expanded beam optical connector (20) for connecting optical fibres. The connector (20) comprises a housing (6), a port (48) within the housing for receiving an end (35) of an optical fibre (38), a cylindrical ferrule (32) within the housing (6) having opposite first and second ends (33, 35), and an optical fibre stub held axially (14) within the ferrule (32) and extending between said ferrule ends (33, 35). The connector (20) also has a lens (8) for projecting and/or receiving an expanded beam (40) optically coupled with the optical fibre stub at the first ferrule end (33). A sleeve (34) surrounds the ferrule (32) and extends towards the port (48) axially away from the second ferrule end (35) to present an open end to the sleeve for receiving a termination ferrule (36) of an optical fibre (38) inserted into the port. The connector (20) has a connector portion (2, 4, 5) for connecting the optical fibre connector (20) to another expanded beam optical fibre connector so that said expanded beam (40) traverses between the connectors. A channel (28) extends through the housing (6) from the port (48) towards the lens (8), the ferrule (32) being secured by means of a cured adhesive (30) to the housing (6) and in alignment with respect to the lens (8), the open end of the sleeve (34) and/or the second end (35) of the ferrule being surrounded by a void (60) within the channel (28).

### BACKGROUND

a. Field of the Invention

The present invention relates to an optical connector for use in a fibre optic communications system, and particularly an expanded beam optical connector for connecting optical fibres.

b. Related Art

An optical fibre communications system may need to be used in a harsh environment where the connector may be subject to impacts, dirt or extremes of temperature and moisture. One application where optical connectors are used in a harsh environment is in the broadcast industry, where cameras or sound equipment are joined to other electronic equipment by means of fibre optic cables extending across open spaces. The cables may be joined together with optical connectors that may have to lie on the open ground where dirt or mud may find their way into the connector.

One known way to increase the reliability of an optical connector is to make use of an expanded collimated optical beam which is projected between mating connector portions. Then, if dirt or moisture comes between the connector portions, this may only obscure or degrade a portion of the expanded beam between the mated connector portions. The expanded size of the expanded beam relative to the dimensions of the connector portions also reduces the need for high mechanical precision in the connector portions.

An example of such an expanded beam optical connector is disclosed in patent document GB 2,408,350. Such a connector can be used with optical fibre cables having a plurality of individual optical fibres, each of which leads to a corresponding lens within the connector and a corresponding expanded collimated beam between the connector portions.

Although such a connector is robust and economical, a problem arises if the optical fibre cable becomes damaged. In this type of connector, the end of the optical fibre is precisely aligned within a ceramic ferrule relative to the expanding lens, with the arrangement being held together with a cured adhesive. Although in principal it might be possible to separate the optical fibre from the connector, this would be difficult and time consuming.

It is an object of the present invention to provide a more convenient expanded beam optical connector.

### SUMMARY OF THE INVENTION

According to the invention, there is provided an expanded beam optical fibre connector for joining optical fibre cables, comprising:
a housing;
a port within the housing for receiving an end of an optical fibre;
a cylindrical ferrule within the housing having opposite first and second ends, an optical fibre stub held axially within the ferrule and extending between said ferrule ends;
an optical system for projecting and/or receiving an expanded beam, said system comprising at least one lens arranged to optically couple said expanded beam with the optical fibre stub at the first ferrule end;
a sleeve surrounding the ferrule and extending towards the port axially away from the second ferrule end to present an open end to the sleeve for receiving a termination ferrule of an optical fibre inserted into the port; and
a connector portion for connecting the optical fibre connector to another expanded beam optical fibre connector so that said expanded beam traverses between said connectors;
wherein a channel extends through the housing from the port towards the optical system, the ferrule being secured by means of a cured adhesive to the housing and in alignment with respect to the optical system, the open end of the sleeve and/or the second end of the ferrule being surrounded by a void within the channel.

The housing may be a one-piece housing, or may be formed from more than one piece or component, for example a main component and also one or more subsidiary components within the main component, the ferrule being secured by means of the cured adhesive to the main component and/or one or more of the subsidiary components. In one embodiment of the invention, the housing includes a main body portion and within the main body portion a tubular portion held to the main body portion, for example being fixed by means of a friction fit and/or a cured adhesive. The ferrule may then be secured by means of the cured adhesive to the tubular portion forming part of the housing.

The expanded beam will also usually be a collimated beam.

Also according to the invention, there is provided an expanded beam optical fibre connector assembly, comprising at least one expanded beam optical fibre connector as claimed in any preceding claim, and an optical fibre cable joined to said optical fibre connector, wherein the optical fibre cable carries at least one optical fibre, an end of an optical fibre being surrounded by a cylindrical termination ferrule at which said optical fibre is terminated, said termination ferrule being seated in the open end of the sleeve such that the end of said optical fibre and the optical fibre stub are aligned and optically coupled.

The void permits free movement of the ferrule prior to curing of the adhesive so that the optical fibre stub can be aligned with respect to the optical system. This removes the need for high precision manufacture of the housing, as in a preferred embodiment of the invention the housing does not contact the ferrule to align the ferrule. Similarly, there is no need for the housing to be made from a plurality of parts having precision dimensions and all in contact with each other and with the ferrule in order to seat the ferrule and the sleeve accurately with respect to the optical system.

In preferred embodiments of the invention, the void is sufficiently large to permit full freedom of movement during alignment, that is, linear translation along and rotation about three orthogonal linear axes. Then, after alignment and curing of the adhesive, there is no contact between the housing and either the ferrule or the sleeve.

In a preferred embodiment of the invention, the optical system comprises just one lens, a glass ball lens, however other types of optical system may be used, for example an aspheric lens, or a multi-lens system. Optical surfaces may be angled with respect to each other, or anti-reflection coated, in order to suppress back-reflections.

The adhesive is preferably a uv-curable adhesive. Ultra-violet radiation may be introduced into the void through the optical system. To help the radiation reach all parts of the adhesive, such radiation may enter the optical system as an uncollimated beam. The void surrounding the ferrule and sleeve may also serve a useful purpose here, by allowing uv radiation to be introduced into the void through the channel port. The hollow interior of the channel and void surrounding the ferrule and sleeve can then help convey the optical radiation to the adhesive to be cured.

The ferrule is therefore preferably surrounded by the cured adhesive which, proximate the first end of the ferrule, fills at least a portion of the void between the ferrule and the housing.

In a preferred embodiment of the invention, the ferrule is secured by means of a cured adhesive that extends between the ferrule and the optical system, in particular, said at least one lens. The adhesive is then preferably index matched and in contact with both the optical fibre stub and a surface of the optical system facing the fibre stub. In this way, back-reflections between the optical fibre stub and optical system can be minimised.

The cured adhesive may advantageously also extend over the first end of the ferrule, in order to make the alignment more secure.

It is particularly helpful if the cured adhesive overlaps the sleeve surrounding the ferrule to secure the sleeve axially with respect to the ferrule. This removes any need for additional components to secure the sleeve axially, and eliminates any need for the housing to provide this feature, or to have any close proximity to the sleeve.

In one embodiment of the invention, at least two vents, and preferably just a pair of vents, leading to the channel through the housing may extend from a location in the channel between the optical system and the second end of the ferrule. As will be described below, such vents are useful when introducing adhesive into the channel. To help prevent any contamination or moisture entering the channel during use of the connector, it is preferred if the cured adhesive blocks both vents.

To aid repair or refitting of an optical fibre to the expanded beam connector, the connector assembly may comprise additionally a retainer that surrounds the optical fibre and which is removably joined to the housing to close the port. The retainer is preferably a one-piece annular retainer, and may be joined by a threaded coupling.

The optical fibre cable may comprise additionally a collar and a spring biasing means between the collar and the retainer to bias the termination ferrule into the open end of the sleeve. In a preferred embodiment of the invention, the collar has an outer diameter larger than the inner diameter of the retainer. The collar is retained on the fibre by the termination ferrule, and therefore also serves to keep the retainer from coming off the cable at the termination end.

The channel preferably includes at least one location feature for guiding the termination ferrule into the open end of the sleeve when the optical fibre is to be joined to the optical fibre connector. The, or each, location feature is dimensioned or positioned so as not to interfere with the free movement of the ferrule and sleeve during the alignment and adhesive curing process.

The invention further provides a method of fabricating an expanded beam optical connector for joining optical fibres, comprising the steps of:
securing an optical fibre stub within a cylindrical ferrule, said ferrule having opposite first and second ends;
placing a sleeve over at least part of the ferrule so that the sleeve extends away from the second ferrule end to present an open end to the sleeve for receiving a termination ferrule of an optical fibre inserted into the port;
forming a substantially hollow housing having a channel extending therethrough;
placing an optical system comprising at least one lens at one end of the channel;
inserting the optical fibre stub and sleeve into the channel such that the first end of the ferrule is brought into proximity with the optical system;
introducing a curable adhesive into a space between the ferrule and the housing;
aligning the ferrule with respect to the optical system so that the optical fibre stub and optical system are optically coupled for the transmission (or reception) of an expanded beam from (or by) the optical system; and
curing the adhesive to secure the relative alignment of the optical fibre stub and optical system;
wherein the channel is formed so that a portion of the channel proximate the ferrule and the sleeve has a diameter or dimensions sufficiently larger than those of the ferrule and sleeve such that the ferrule and sleeve may be freely moved without contacting the housing to optimise the optical coupling of the optical fibre stub and the optical system prior to curing of the adhesive.

Preferably, said portion of the channel surrounds at least the second end of the ferrule and the extending sleeve so that these may be freely manipulated without contacting the housing to optimise the optical coupling.

The optical alignment may be monitored or quantified in a production environment by means of a test instrument including an optical fibre terminated by a termination ferrule that is removably inserted into the open end of the sleeve. Expanded beam optical radiation may be transmitted at the optical system, with the test instrumentation then monitoring the intensity of optical radiation received by the test optical fibre via the optical fibre stub. Alternatively or additionally, the test optical fibre may transmit optical radiation into the optical fibre stub, with the test instrument then monitoring the intensity and/or beam shape of the expanded optical radiation transmitted from the optical system.

When the housing has at least two vents as described above, the method may comprise the steps of:
introducing the adhesive through a first one of the vents;
monitoring the appearance of adhesive at a second vent; and
controlling the amount of adhesive introduced through the first vent in response to the appearance of adhesive at the second vent.

The invention further provides a method of fabricating an expanded beam optical connector for joining optical fibres, comprising the steps of:
securing an optical fibre stub within a cylindrical ferrule, said ferrule having opposite first and second ends;
placing a sleeve over at least part of the ferrule so that the sleeve extends away from the second ferrule end to present an open end to the sleeve for receiving a termination ferrule of an optical fibre inserted into the port;
forming a substantially hollow first component having a first channel extending therethrough;
placing an optical system comprising at least one lens at one end of said first channel;
inserting the optical fibre stub and sleeve into said first channel such that the first end of the ferrule is brought into proximity with the optical system;
introducing a curable adhesive into a space between the ferrule and the housing;
aligning the ferrule with respect to the optical system so that the optical fibre stub and optical system are optically coupled for the transmission (or reception) of an expanded beam from (or by) the optical system;
curing the adhesive to secure the relative alignment of the optical fibre stub and optical system;
incorporating said first component in an optical fibre connector;
wherein the first channel is formed so that a portion of the first channel proximate the ferrule and the sleeve has a diameter or dimensions sufficiently larger than those of the ferrule and sleeve such that the ferrule and sleeve may be freely moved without contacting the housing to optimise the optical coupling of the optical fibre stub and the optical system prior to curing of the adhesive. This method may then comprise the steps of forming a substantially hollow second component having a second channel extending therethrough, and securing the first component within the second component.

The invention additionally provides a method of fabricating an expanded beam optical connector assembly, comprising the steps of:
fabricating an expanded beam optical connector according to the invention;
terminating an optical fibre with a termination ferrule, said termination ferrule being dimensioned to be securely received within said sleeve; and
inserting the terminated optical fibre into said open end of said sleeve until said termination ferrule is securely received within said sleeve with the optical fibre being optically coupled with the optical fibre stub.

The open end of said channel may then be closed with the removably fixable annular retainer.

The assembly of the connector assembly may then include:
inserting the annular retainer over the optical fibre;
fixing a collar to the optical fibre;
placing a spring biasing means between the collar and the retainer; and
fixing the retainer to the housing such that the spring biasing means helps to retain the termination ferrule in the sleeve.

The connector assembly may then be finished in a conventional manner by fixing an external connector body and water-tight seals about one or more of the connector assemblies, including a bushing or tail where a multi-fibre optical cable enters the external connector body.

### BRIEF DESCRIPTION OF THE DRAWINGS

The invention will now be further described, by way of example only, and with reference to the accompanying drawings, in which:

FIG. 1 is perspective view of an expanded beam connector assembly according to a preferred embodiment of the invention showing a generally cylindrical connector body portion or shell with a hermaphroditic connection mechanism that surrounds a central fibre optic housing that holds at least one expanded beam optical connector according to the invention;

FIG. 2 is a view of two of the expanded beam connector assemblies of FIG. 1 when joined together;

FIG. 3 is a front end view of the central fibre optic housing of FIG. 1;

FIG. 4 is a fragmentary cross-section through line IV-IV of FIG. 3, showing internal components that form an expanded beam optical connector according to a first preferred embodiment of the invention;

FIG. 5 is a rear end view of the central fibre optic housing of FIG. 1;

FIG. 6 is a partial cross-section of the expanded beam connector similar to that of FIG. 3, showing how the ferrule and split sleeve when first inserted into the channel are free to move and rotate in a void between the ferrule sleeve assembly and the channel walls;

FIGS. 7 and 8 are partial cross-sections of the expanded beam connector similar to that of FIG. 3, showing how a uv-curable adhesive is injected in one end of the channel while the ferrule and sleeve are aligned with respect to a lens prior to uv curing of the adhesive; and

FIGS. 9 to 10 are cross-sections illustrating the internal components and method of assembly of an expanded beam optical connector according to a second preferred embodiment of the invention.

### DETAILED DESCRIPTION

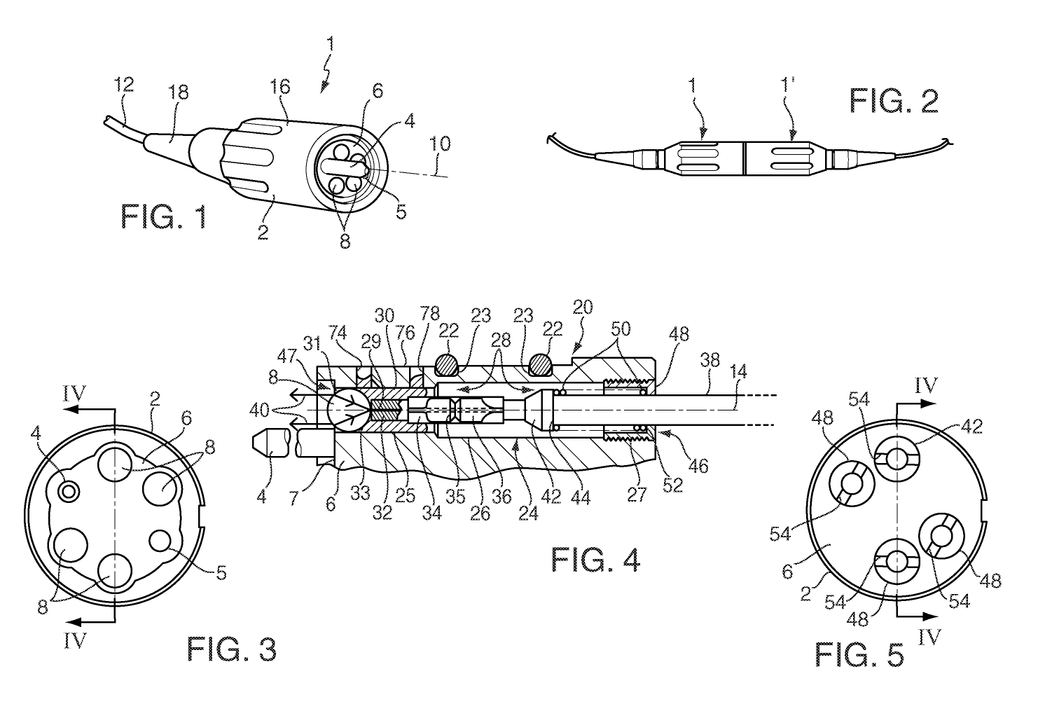

FIG. 1 shows a perspective view of an expanded beam connector assembly 1 having a generally cylindrical connector body portion or shell 2 with a hermaphroditic connection mechanism 4, 5 that surrounds a central fibre optic housing 6. The housing 6 holds four lenses 8, which here are spherical lenses, for four corresponding optical communication channels. The connector shell 2 defines a connector axis 10 which is in-line with a multi-fibre optic cable 12 that is terminated by the connector assembly 1, and parallel with an expanded beam connector axis 14, as shown in FIG. 4. The axis 14 is perpendicular to a front face 7 of the housing 6.

It should be noted however, that the number of lenses 8 and hence the number of communication channels is not critical to the invention, and that the connector assembly 1 may have any convenient number of lenses 8, for example between one and twelve lenses.

FIG. 2 shows how two such connector assemblies 1, 1′ may be joined together. As will be explained in detail below, a spherical lens 8 in each connector assembly is optically coupled to an optical channel through the housing 6 provided by an optical fibre, and projects and/or receives an expanded collimated optical beam from an opposed similar lens in the other connector assembly 1′.

The two connector assemblies 1, 1′ have a hermaphroditic coupling mechanism, comprising in each connector a pin 4 and a matching recess 5 which seat and lock with a similar pin and recess on the other connector assembly when the two connector assemblies are brought together along an axial direction.

Although not illustrated, each connector assembly 1, 1′ may be provided with a retained plastic moulded dust cap to cover and protect the fibre optic housing 6 within the connector body 2 when the connector assembly is not joined to another similar connector assembly.

In general, as shown in FIG. 1, the connector assembly 1 may utilize more than one expanded collimated beam and so there may be more than one spherical lens 8 and more than one corresponding optical channel through the housing 6. The spherical lenses 8 and optical channels will not, in general, have optical axes 14 which are coincident with the connector assembly axis 10 of the cylindrical housing 6, but will be positioned off-axis and usually parallel with the connector assembly axis 10 so that the expanded beams come into alignment as the two mated connector assemblies 1, 1′ are locked together.

An advantage of this type of hermaphroditic design is that there can be no confusion in the field with male or female types and there is no requirement for adaptors. The connector assembly 1 may, however be used also with panel-mount bulkhead connector shells. An outermost rubber grip ring sleeve 16 and flexible strain relief boot 18 are also provided.

FIG. 4 is a cross-section through a part of the housing 6, showing a first embodiment of one expanded beam optical connector 20. For clarity in FIG. 4 and subsequent drawings, just one of the spherical lenses 8 is illustrated together with the components that make up the optical channel leading to the lens 8. As can be seen from FIGS. 1, 3 and 5, there are four such optical connectors 20 in the optical connector assembly 1, each of which shares a common housing 6.

A water tight seal is made between the mated connector assembly shell 2 and the housing 6 by use of internal O-rings 22 which are seated in grooves 23 that extend around the full circumference of the housing 6.

The housing 6 has a stepped generally cylindrical bore 24 having front, central and rear cylindrical portions 25, 26, 27 which are concentric with one another about the connector axis 14. The stepped cylindrical portions 25, 26, 27 define a channel 28 through the housing 6. The spherical lens 8 fits within the front cylindrical portion 25 at a front end 47 of the channel 28. The lens 8 is bonded to surfaces of the front cylindrical portion 25 by means of a uv-cured adhesive 30. Cured adhesive 31 may also be used to seal around the external periphery of the lens 8, between the lens 8 and the housing 6.

The internal adhesive 30 also bonds the lens 8 to a zirconia ceramic cylindrical ferrule 32. A fibre stub 29 is held along the central axis of the ferrule 32, an end face 33 of which abuts or nearly contacts the lens 8.

A zirconia ceramic split sleeve 34 is engaged around the half of the ferrule 32 furthest from the lens 8. Optionally, a cured adhesive 30 overlaps the split sleeve 34 to retain this to the ferrule 32. The sleeve 34 may therefore be secured axially with respect to the ferrule 32 by means of a friction fit and/or by means of the overlapping cured adhesive 30. Alternatively, the split sleeve 34 can be bonded to the ferrule 32 first.

In FIG. 4 the split sleeve 34 is shown partially cut away so that the end 35 of the ferrule 32 furthest from the lens can be seen in abutting contact with a similar ferrule 36, referred to herein as a “termination ferrule” held securely within the split sleeve 34 where this projects in an axial direction from the ferrule 32. The termination ferrule 36 terminates an optical fibre (not shown) within protective sheathing to form a buffered fibre 38 that has been inserted into the channel 28. This split sleeve and ferrule arrangement naturally aligns the optical fibre within the buffered fibre 38 and ferrule 32. The optical coupling between these fibres and between the lens 8 and optical fibre within the ferrule 32 is such that the lens 8 is arranged to receive and focus an expanded collimated optical beam 40 onto the end of the optical fibre within the ferrule 32, and also to receive optical radiation received from the optical fibre cable 38 as this is projected from the end of the optical fibre within the ferrule 32 and to collimate this into a similar expanded collimated optical beam 40.

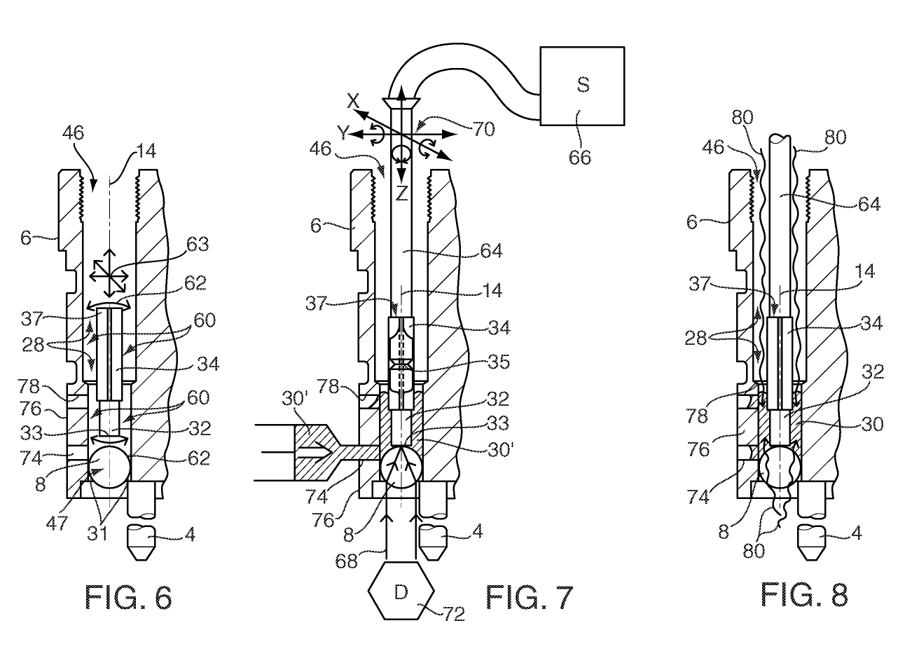

It should be noted from FIG. 4 that because there is no contact between the ferrule 32 and the surrounding housing 6, which are completely separated from each other, the ferrule 32 is both secured and aligned with respect to the lens 8 by means of the cured adhesive 30. The cured adhesive 30 fills a void 60 (see FIG. 6) that would otherwise exist between the ferrule 32 and the housing 6 in the vicinity of the end of the ferrule 32 proximate the lens 8.

The buffered fibre 38 is terminated by the termination ferrule 36 behind which is a collar 42 having an annular shoulder 44 directed towards the opposite end 46 of the channel 28 from the lens 8, referred to herein as a “port end” 46 of the channel 28. The port end 46 of the channel 28 is closed by means of an annular retainer 48 which is threaded into the port end 46 of the channel 28. The buffered fibre 38 passes through the centre of the retainer 48. A helical spring 50 is held between an inner surface 52 of the retainer 48 and the shoulder 44 of the collar 42. The spring 50 is in compression when the retainer 48 may optionally be threaded to the housing 6, which causes the spring 50 to apply a force that keeps the termination ferrule 36 fully engaged within the split sleeve 34. Other means of holding the retainer to the housing may be employed, for example a separate rear cover (not shown)_which is fixed to the housing. Either of these approaches will serve to keep the optical fibre within the buffering 38 fully engaged with the fibre stub 29 within the ferrule 32.

The retainer 48 is provided with an external slot 54 with which a tool (not shown) may be engaged to connect and disconnect the retainer 48 to the housing 6.

FIGS. 6-8 show the main assembly steps for the formation of the expanded beam optical connector 20. The lens 8 is first inserted into the front end 47 of the channel 28 and sealed with adhesive 31. The lens 8 is held in by friction in an interference fit and is retained with a small amount of cured epoxy adhesive 31 around the exposed periphery of the lens 8. The split sleeve 34 is then fitted to the ferrule 32 into which the optical fibre stub 29 will already have been located. As can be seen from the schematic representations of FIG. 6, if the ferrule 32 and split sleeve 34 are inserted into the channel 28, then a void 60 extends fully around the ferrule 32 and sleeve 34 such that there are both rotational 62 and translational 63 degrees of freedom of movement of the ferrule and sleeve within the channel 28.

FIG. 7 shows how the optical fibre stub 29 within the ferrule 32 is aligned and secured with respect to the lens 8. A cylindrical test probe 64 having similar dimensions to the termination ferrule 36 is inserted into an open end 37 of the split sleeve 34 which is shown in partial cutaway in FIG. 7 for clarity. The probe 64 has a similar optical fibre to that of the optical fibre cable 38 and therefore duplicates the alignment that is needed for the optical fibre within the cable 38 to be coupled optically with the fibre stub 29 within the ferrule 32. A source (S) 66 of optical radiation is coupled to the fibre probe to transmit through the fibre stub 29 and lens 8. The probe 64 is clamped within a micro-positioning apparatus 70 shown schematically in FIG. 7. The micro-positioning apparatus 70 has three degrees of linear movement (x,y,z) as well as at least two rotational degrees of freedom around (x,y) axes at right angles to the optical axis 14.

The micro-positioning stage 70 positions the ferrule and sleeve assembly such that the collimated beam emitted from the lens and monitored by a suitable detector (D) 72, is perpendicular to the front face 7 of the housing 6 and parallel with the optical axis 14.

When the arrangement is approximately optically coupled, uncured adhesive 30′ is injected through an aperture or vent 74 that extends from an external surface 76 of the housing 6 into the front cylindrical portion 25 of the channel 28 nearest the lens 8. A similar second aperture or vent 78 leads to the front cylindrical portion 25 of the channel 28 nearest the central portion 26 of the channel 28.

As uncured adhesive 30′ is injected into the channel 28 to fill the void 60 in the front cylindrical portion 25, uncured adhesive 30′ will appear at the second vent 78 which is a signal that sufficient adhesive 30′ has been introduced into the void 60. It should be noted here that neither of the vents 74, 78 is necessary to vent air, as during this process the port end 46 of the channel 28 is open.

Optionally, to ensure that adhesive 30′ fully contacts and fills any gaps between the end 33 of the fibre stub 29 and lens 8, the adhesive may be introduced prior to moving the ferrule/sleeve assembly along the optical z-axis 14 into position with the lens.

The optical alignment of the fibre optic stub 29 within the ferrule 32 is then adjusted or maintained by the micro-positioning apparatus 70 to optimise the optical coupling while uncollimated ultraviolet radiation 80 is introduced through the lens 8 and/or down the open channel 28 in order to cure the adhesive 30. Once the adhesive is set, then the test probe 64 is pulled out of the open end 37 of the split sleeve 34, following which a terminated optical fibre cable 38 can be inserted into the open sleeve 34 and the annular retainer 48 used to close the channel 28, as described above.

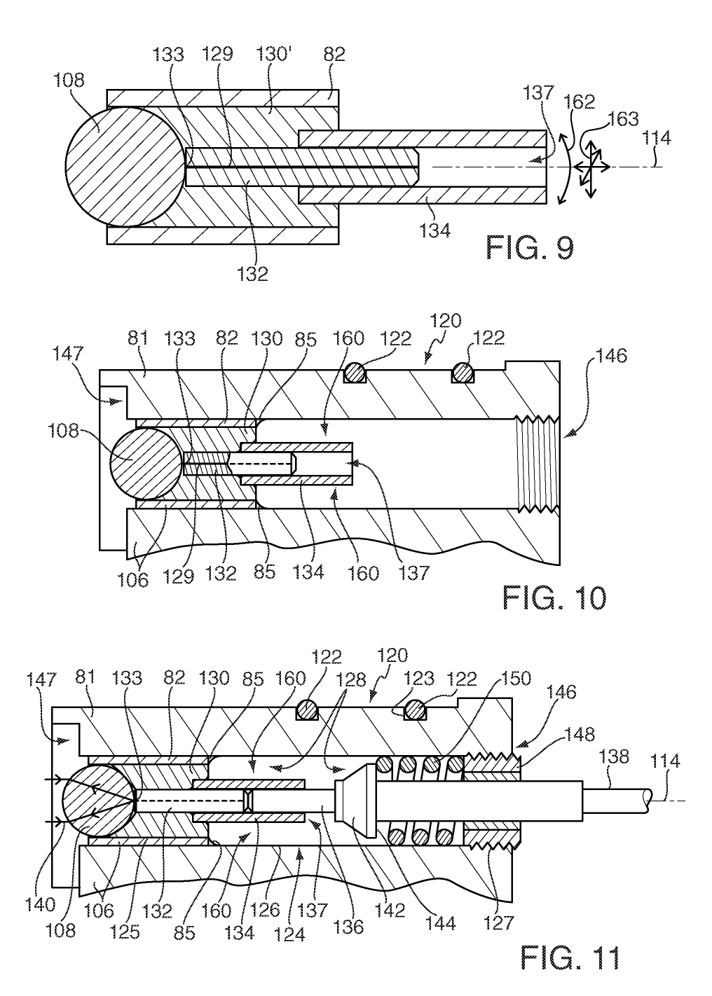

Reference is now made additionally to FIGS. 9, 10 and 11 which show the internal components and method of assembly of an expanded beam optical connector 120 according to a second preferred embodiment of the invention, in which feature and components corresponding with those of the first embodiment 20 are denoted by reference numerals incremented by 100 over those of the first embodiment 20.

The second embodiment differs from the first embodiment in that each optical connector 120 has a housing formed from two components, namely a “first” or a main component 81 and also a “second” or a subsidiary component 82, which when secured together form a housing 106 for an optical assembly 108, which is in this example a ball lens. The main component 81 is similar to the housing 6 of the first embodiment 20, but is lacking in a bore 124 an inwardly stepped portion 25 nearest the ball lens 108. In this embodiment, this stepped portion 125 is provided by the subsidiary component 82, which is a tubular zirconia ceramic sleeve secured to the main body component 81 of the housing 108 by a friction fit and/or by means of an optional adhesive bead 85.

In this embodiment, as shown in FIG. 9, the alignment between the lens 108 and an end 133 of a fibre stub 129 is made before final assembly of the housing from the main and subsidiary components 81, 82. After the fibre stub 129 is inserted into the ferrule 132, a zirconia ceramic split sleeve 134 is placed partially over the sleeve 132 so that the split sleeve 134 presents an open end 137, as before.

Uncured adhesive is then inserted into the void between the ferrule and sleeve assembly 132, 134 and the surrounding tubular component 82. The relative alignment between the end 133 of the fibre stub 129 and lens 108 is then performed in a similar manner to that described above for the first embodiment, during which u.v. radiation is used to cure an adhesive 130 bonded to the lens 108, ferrule 132 and optionally also the ceramic sleeve 134.

The sub-assembly formed by the lens 108, tubular component 82, cured adhesive 130, ferrule 132, fibre stub 129 and sleeve 134, is then inserted into a front end 147 of the main component 81 and optionally secured using the adhesive bead 85. A termination ferrule 136 of a terminated optical fibre assembly 138, 142, 144 may then be plugged into the open end 137 of the ceramic sleeve 134 and then secured in place by a spring loaded annular retainer 148, 150 at a rear end 146 of the housing 106.

As with the first embodiment 20, there may be several such optical connectors 120 in the optical connector assembly 1, each of which shares a common housing 106.

An advantage of this embodiment is that the optical alignment and u.v. curing may be conveniently performed without in any way having to reach inside a constricted space, such as the channel 28, 128 through the housing 6, 106. This arrangement also avoids any need to form vents 74, 76 through the housing 106.

The invention provides a number of benefits in terms of manufacturing efficiency and cost. Because the housing 6, 106 does not itself align the optical components within the housing, the housing can be formed in one or more pieces with a channel 28, 128 that extends from the port end 46, 146 towards to the opposite lens end 47, 147. Only the lens aperture at the front cylindrical portion 25, 125 may need to be dimensioned accurately to fit an optical component 8, 108. Because the ferrule 32, 132 is secured solely by means of the cured adhesive 30, 130, no other mechanical components are required in the housing 6, 106 to secure this alignment.

Both the lens 8, 108 and the ferrule 32, 132 are permanently bonded together by means of the uv-curable adhesive 30, 130 which is substantially transparent to the optical radiation 40, 140 to be transmitted or received using the expanded beam optical connector 20, 120.

The ferrule 32, 132 may be a conventional ceramic optical ferrule, for example being 1.25 mm or 2.50 mm in diameter. Such ferrules 32, 132 are readily available and inexpensive. Because the cured adhesive 30, 130 extends fully around and over the fibre stub end 33, 133 of the ferrule 32 closest the lens 8, contamination will not enter the interface between the optical fibre stub 29 and the lens 8.

As explained above, there is no need for the split sleeve 34, 134 to be secured directly to the housing 6, 106 as the cured adhesive 30, 130 preferably overlaps the sleeve 34, 134 surrounding the ferrule 32, 132 to secure the sleeve axially with respect to the ferrule. The adhesive 30, 130 therefore extends at least partially and preferably fully around the circumference of the sleeve 34, 134 to make secure joins. The alignment is therefore set entirely by the cured adhesive 30, 130.

In this example, the sleeve is a split sleeve having a C-shape in cross-section. The sleeve may, however, have any suitable shape or be formed in any resilient material that will apply an inward compressive force on both ferrules 32, 132, 36, 136.

Although the optical system described above comprises just one spherical lens 8, 108, the invention is also applicable to other optical systems having multiple optical elements or aspherical optical elements. The optical fibre stub 29, 129 may be in contact with the spherical lens 8, 108 or other optical elements, or may be separated by a distance necessary to achieve good optical coupling between the optical system and the fibre stub 29, 129 within the ferrule 32, 132.

The optical system may be made to include optical isolating elements to minimise reflections or the fibre stub 29, 129 itself may be an optical isolator.

If it becomes necessary to replace or repair the buffered fibre 38, 138, then this can be done by removing the retainer 48, 148 and inserting a different terminated buffered fibre 38, 138 into the channel 28, 128 and sleeve 34, 134 as described above, after which the channel 28, 128 is again closed by the retainer 48, 148.

When the connector assembly 1 has multiple expanded beam optical connectors 20, 120, then each buffered fibre 38, 138 will normally be part of a single multi-optical fibre cable 12 carrying multiple optical fibre strands.

It is appreciated that certain features of the invention, which are, for clarity, described in the context of separate embodiments, may also be provided in combination in a single embodiment. For example, the vents 74, 76 shown in the first embodiment of the expanded beam optical connector 20 may be adapted for use with the second embodiment 120, by forming the vents 74, 78 through both the main body portion 81 and the tubular portion 82 of the housing 106, if it is desired to use with the second embodiment 120 the alignment and bonding techniques described in the first embodiment 20.

The expanded beam optical fibre connector described above therefore provides a convenient and economical expanded beam optical connector assembly.

1. An expanded beam optical fibre connector for joining optical fibre cables, comprising:
a housing;
a port within the housing for receiving an end of an optical fibre;
a cylindrical ferrule within the housing having opposite first and second ends, an optical fibre stub held axially within the ferrule and extending between said ferrule ends;
an optical system for projecting and/or receiving an expanded beam, said system comprising at least one lens arranged to optically couple said expanded beam with the optical fibre stub at the first ferrule end;
a sleeve within the housing surrounding the ferrule and extending towards the port axially away from the second ferrule end to present an open end to the sleeve for receiving a termination ferrule of an optical fibre inserted into the port; and
a connector portion for connecting the optical fibre connector to another expanded beam optical fibre connector so that said expanded beam traverses between said connectors;
wherein a channel extends through the housing from the port towards the optical system, the ferrule being secured by means of a cured adhesive to the housing and in alignment with respect to the optical system, the open end of the sleeve and/or the second end of the ferrule being surrounded by a void within the channel.

2. An expanded beam optical fibre connector as claimed in claim 1, in which the housing is a one-piece housing.

3. An expanded beam optical fibre connector as claimed in claim 1, in which the housing is formed from more than one piece or component.

4. An expanded beam optical fibre connector as claimed in claim 3, in which the housing includes a main component and also one or more subsidiary components within the main component, the ferrule being secured by means of said cured adhesive to the main component and/or one or more of said subsidiary components.

5. An expanded beam optical fibre connector as in claim 3, in which the housing includes a main body portion and within the main body portion a tubular portion held to the main body portion, the ferrule being secured by means of said cured adhesive to the tubular portion forming part of the housing.

6. An expanded beam optical fibre connector as claimed in claim 5, in which the tubular portion of the housing is fixed by means of a friction fit and/or a cured adhesive to the main body portion of the housing.

7. An expanded beam optical fibre connector as claimed in claim 1, in which the ferrule is surrounded by the cured adhesive which proximate the first end of the ferrule fills at least a portion of the void between the ferrule and the housing.

8. An expanded beam optical fibre connector as claimed in claim 1, in which the ferrule is secured solely by means of the cured adhesive.

9. An expanded beam optical fibre connector as claimed in claim 1, in which the ferrule is secured by means of a cured adhesive that extends between the ferrule and the optical system.

10. An expanded beam optical fibre connector as claimed in claim 9, in which the ferrule is secured by means of a cured adhesive that extends between the ferrule and said at least one lens.

11. An expanded beam optical fibre connector as claimed in claim 1, in which the cured adhesive extends over the first end of the ferrule

12. An expanded beam optical fibre connector as claimed in claim 1, in which the cured adhesive overlaps the sleeve surrounding the ferrule to secure the sleeve axially with respect to the ferrule.

13. An expanded beam optical fibre connector as claimed in claim 1, wherein at least two vents leading to the channel through the housing extend from a location in the channel between the optical system and the second end of the ferrule.

14. An expanded beam optical fibre connector as claimed in claim 13, in which there is a pair of vents spaced apart along the length of the channel.

15. An expanded beam optical fibre connector as claimed in claim 14, in which the cured adhesive blocks both vents.

16.-19. (canceled)

20. A method of fabricating an expanded beam optical connector for joining optical fibres, comprising the steps of:
securing an optical fibre stub within a cylindrical ferrule, said ferrule having opposite first and second ends;
placing a sleeve over at least part of the ferrule so that the sleeve extends away from the second ferrule end to present an open end to the sleeve for receiving a termination ferrule of an optical fibre inserted into the port;
forming a substantially hollow housing having a channel extending therethrough;
placing an optical system comprising at least one lens at one end of the channel;
inserting the optical fibre stub and sleeve into the channel such that the first end of the ferrule is brought into proximity with the optical system;
introducing a curable adhesive into a space between the ferrule and the housing;
aligning the ferrule with respect to the optical system so that the optical fibre stub and optical system are optically coupled for the transmission (or reception) of an expanded beam from (or by) the optical system; and
curing the adhesive to secure the relative alignment of the optical fibre stub and optical system;
wherein the channel is formed so that a portion of the channel proximate the ferrule and the sleeve has a diameter or dimensions sufficiently larger than those of the ferrule and sleeve such that the ferrule and sleeve may be freely moved without contacting the housing to optimise the optical coupling of the optical fibre stub and the optical system prior to curing of the adhesive.

21. A method as claimed in claim 20, in which the housing has at least two vents leading to the channel that extend from a location in the channel between the optical system and the second end of the ferrule, the method comprising the steps of:
introducing the adhesive through a first one of the vents;
monitoring the appearance of adhesive at a second vent; and
controlling the amount of adhesive introduced through the first vent in response to the appearance of adhesive at the second vent.

22. A method of fabricating an expanded beam optical connector for joining optical fibres, comprising the steps of:
securing an optical fibre stub within a cylindrical ferrule, said ferrule having opposite first and second ends;
placing a sleeve over at least part of the ferrule so that the sleeve extends away from the second ferrule end to present an open end to the sleeve for receiving a termination ferrule of an optical fibre inserted into the port;
forming a substantially hollow first component having a first channel extending therethrough;
placing an optical system comprising at least one lens at one end of said first channel;
inserting the optical fibre stub and sleeve into said first channel such that the first end of the ferrule is brought into proximity with the optical system;
introducing a curable adhesive into a space between the ferrule and the housing;
aligning the ferrule with respect to the optical system so that the optical fibre stub and optical system are optically coupled for the transmission (or reception) of an expanded beam from (or by) the optical system;
curing the adhesive to secure the relative alignment of the optical fibre stub and optical system;
incorporating said first component in an optical fibre connector;
wherein the first channel is formed so that a portion of the first channel proximate the ferrule and the sleeve has a diameter or dimensions sufficiently larger than those of the ferrule and sleeve such that the ferrule and sleeve may be freely moved without contacting the housing to optimise the optical coupling of the optical fibre stub and the optical system prior to curing of the adhesive.

23. A method as claimed in claim 22, comprising the steps of forming a substantially hollow second component having a second channel extending therethrough, and securing the first component within the second component.

24.-26. (canceled)
